(19) United States
(12) Patent Application Publication
(10) Pub. No.: US 2020/0386003 A1
(43) Pub. Date: Dec. 10, 2020

(54) HANDRAIL CATCH BASKET

(71) Applicant: Ty-Flot, Inc., Manchester, NH (US)

(72) Inventors: Darrell A. Moreau, Manchester, NH (US); Andre W. Moreau, Bedford, NH (US)

(21) Appl. No.: 16/430,850

(22) Filed: Jun. 4, 2019

(51) Int. Cl. E04G 5/00; B25H 3/02; B25B 29/00

(52) U.S. Cl. CPC E04G 5/003; B25B 29/00; B25H 3/02

(57) ABSTRACT

The present invention is a handrail catch basket designed for working on the opposite side of a handrail. During operation, the basket is placed under a drop hazard that is being worked on and is placed so as to capture objects that may drop inadvertently. The basket has a chamber to contain tools, and a 360-degree trough around the main chamber to contain the parts or tools, if inadvertently angled while removing. The basket may also have ready anchor points to attach tethers, and stabilizer brackets that will hold onto a handrail and keep it from tipping during use. The base is a strainer which allows water to run through to keep the parts wet which helps reduce radioactive contamination from spreading.

### BACKGROUND OF THE INVENTION

### 1. Field of the Invention

The present invention relates generally to construction safety tools. Particularly, the present invention relates to devices for preventing dropped object accidents on construction sites from increased heights.

### 2. Description of the Prior Art

It is a generally accepted safety practice to secure a workman's tools in some manner when working from a ladder or above ground level. Over the years, different types of devices for preventing the accidental dropping and/or loss of a tool and a tool accessory have been attempted when working in overhead situations. A dropped tool or tool accessory could be hazardous for personnel working below or the dropped tool or tool accessory could potentially damage a vital piece of equipment. This can occur when the tool is mishandled, bumped, or jarred; the tool then becoming dislodged from the user's hand and free to fall to whatever is beneath the worker. In some cases, this can be a passerby, another worker or even vital plant equipment.

Typically, the tools are secured to the worker with a tether or in a holster of some sort. Generally, tethers are lightweight, optionally retractable, and have light duty snap hooks at each end for snap connection to the tool and to the worker's belt or harness. Some such tethers even use plastic snaps. In some cases, a loop is formed around the worker's wrist with the free end having a snap connectable to a tool. Others have disclosed the use of a hook and loop type fastener to secure the tool to the worker's hand. The use of such safety tethers and lanyards is becoming increasingly necessary, especially in industrial centers where workers are constantly exposed to the hazards of falling tools, sometimes from many feet.

Many attempts have been made to secure tools to tethers and users. Some are successful and easy to use while others are makeshift and lack the quality needed to sustain heavier tools. Devices have been created to allow for lanyard attachment to hand tools. Some devices include using eye hooks, or D-rings with webbing secured by tape or heat shrink tubing. Other devices are tubular and used over the butt end of screw drivers and other tools with handles such as, for example, pliers, hammers, cutters, etc. These tubular devices are normally heat shrinkable onto the tool or are self-insertable device made of a resilient material that provides a suction force when the tool handle or butt end is inserted into the tubular device. The suction force created upon insertion of the tool into the tubular device prevents the tool from being easily pulled out or separated from the tubular device.

One such device is a bracelet type tool drop preventing device disclosed in Japanese Patent Application JP08-108538 and published as JP09-272077. Drawing 5 of the Japanese patent application discloses a screwdriver with a rotary ring that is attached to the screwdriver using a rubber stopper.

The significance of such events cannot be overstated. On the worker side, an injury caused by a dropped object occurs every 10 minutes in the United States. That represents more than 50,000 dropped object accidents every year. In the kitchen, the injury may be minimal, but on a construction site, the impact is much more severe. Just one dropped object accident can take a life and bankrupt your business. According to the National Safety Council, one employee death costs more than 1.4 million dollars.

### SUMMARY OF THE INVENTION

Despite the very real and present danger that dropped object accidents present to both the business owner and the worker, the industry has failed to provide technology which meets the current demands of the market. The present invention stops dropped object accidents in their tracks with comprehensive dropped object prevention tools, and training, designed for real world work-place challenges.

The present invention employs a revolutionary system used to capture tools and objects when working at heights. The system is designed to capture tools at all times (including during tool transfers) and reduce the risk of tools being dropped on people or property below. The present system when used correctly, allows workers to safely and securely carry and use tools at heights and manage tools effectively. Specifically, the present invention was designed for working on the opposite side of a handrail. The catch basket is placed under the drop hazard that is being worked on so as to capture objects that may drop inadvertently.

In addition to the main basket, the present invention also contains some features to prevent drop hazards. One such feature are the ready anchor points by which tethers may be attached. Another feature to increase overall safety is a 360-degree trough which circumvents the main basket (regardless of basket shape). By surrounding the basket, the trough is capable of containing the parts if inadvertently angled while removing.

In some embodiments, the catch basket also has stabilizer brackets that will hold onto a handrail and keep it from tipping on one direction and an additional handle 2″×1″ which facilitates preventing the basket from tipping in the other direction. This set up will allow the basket holder to stand on the right side of the worker or the left side of the worker due to its concentric design.

In yet another embodiment, the base is a strainer which allows water to run through to keep the parts wet which helps reduce radioactive contamination from spreading.

As described above, in one embodiment, the present invention is a handrail catch basket supported by a handrail for containing tools and attaching safety tethers for further tools. The basket has a base with a side wall extending from a bottom sheet, and an upper rim extending from the side wall. The base defines an internal chamber and trough for catching tools which are and are not attached via safety tethers.

The basket has a brace which provides additional support along the upper rim. The brace has two arms extending from a main portion at an angle. Each of the two arms abut a respective portion of the side wall of the base and are supported on a respective portion of the rim portion of the base.

The basket has at least two points of support which engage the handrail, and each are capable of physically supporting the entire weight of the basket and several tools. One such point of support is a stabilizing bracket which has a supporting arm, securely supporting the base, and a main body extending between the supporting arm and a retaining arm. Together, the main body and the retaining arm define a railing-space under the bracket. Respective under-surfaces of the main body and the retaining arm which face the railing-space are as close to friction-free as possible so as to facilitate the basket in being able slide freely side-to-side along the handrail.

In one embodiment a second of the at least two points of support is a handle. The handle has a neck which is attached to and securely supports the base. A shaft of the handle extends between the neck and a grip. The grip capable of being supported by hand or by attachment via attachment point, such as a u-shackle, located along the grip.

### BRIEF DESCRIPTION OF THE DRAWINGS

FIG. 1 is a perspective view of one embodiment of the handrail catch basket according to the present invention.

FIG. 1A is a perspective view of one embodiment of the handrail catch basket according to the present invention on a tilted handrail illustrating use of the first retaining system; and FIG. 1B is a second view of the handrail catch basket system illustrating use of the second retaining system of the present invention.

FIG. 2 is a top planar view showing locations and interactions of the strainer, ledge, brackets and fasteners, for the embodiment shown in FIG. 1.

FIG. 3 is a front cross-sectional view of FIG. 2.

FIG. 4 is an enlarged view of the cross-sectional view of FIG. 3.

FIG. 5 is an exploded view of the ledge of FIG. 1.

FIG. 6 is a top perspective view of the base of FIG. 1.

FIG. 7 is a top perspective view of a bracket of FIG. 1.

FIG. 8 is a top perspective view of an anchor point of FIG. 1.

FIG. 9 is a top perspective view of a first brace of FIG. 1.

FIG. 10 is a top perspective view of a second brace of FIG. 1.

FIG. 11 is a top perspective view of a handle of FIG. 1.

FIG. 12 is enlarged view of a portion of the handle of FIG. 11.

### DETAILED DESCRIPTION OF THE INVENTION

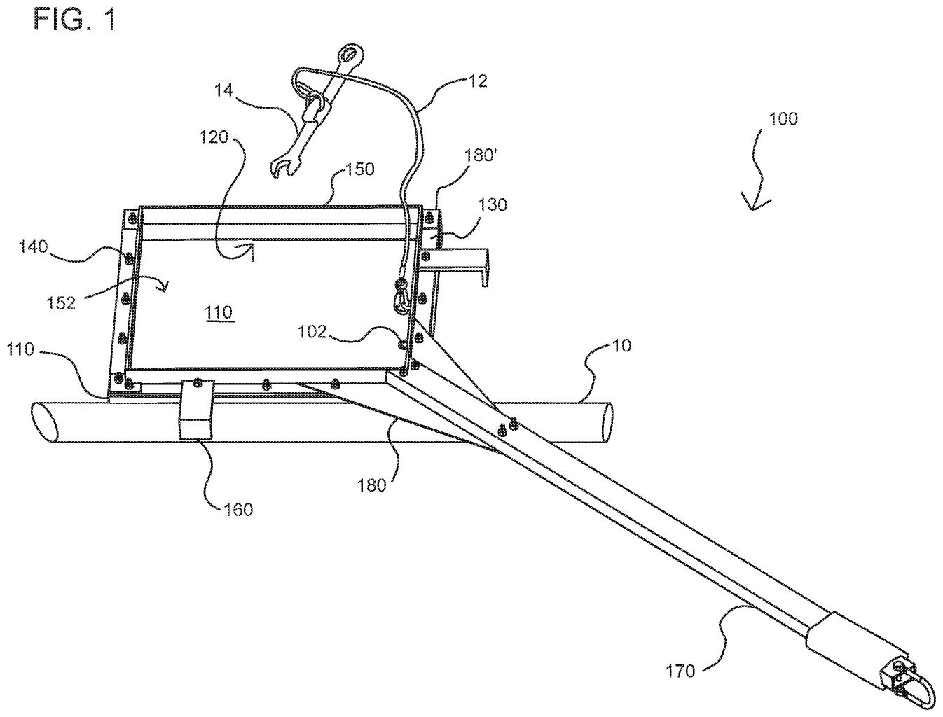

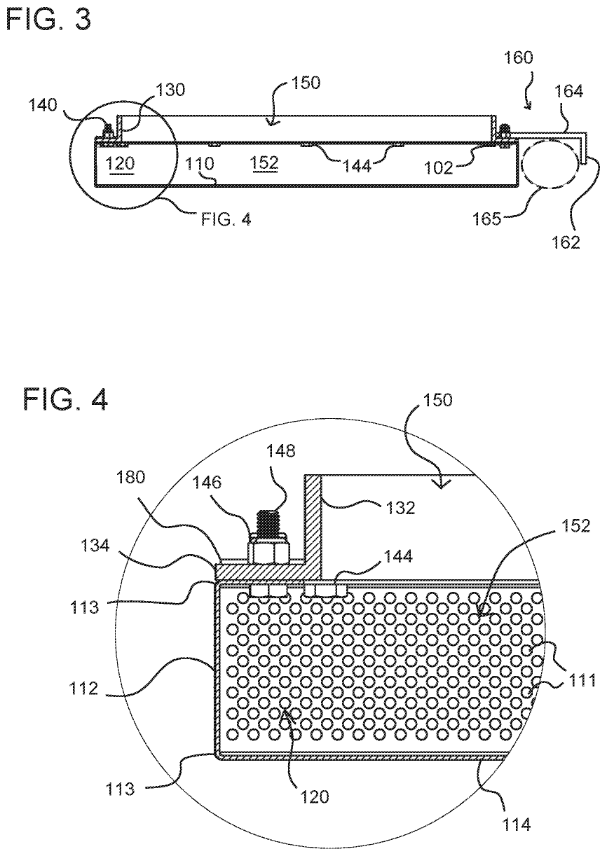

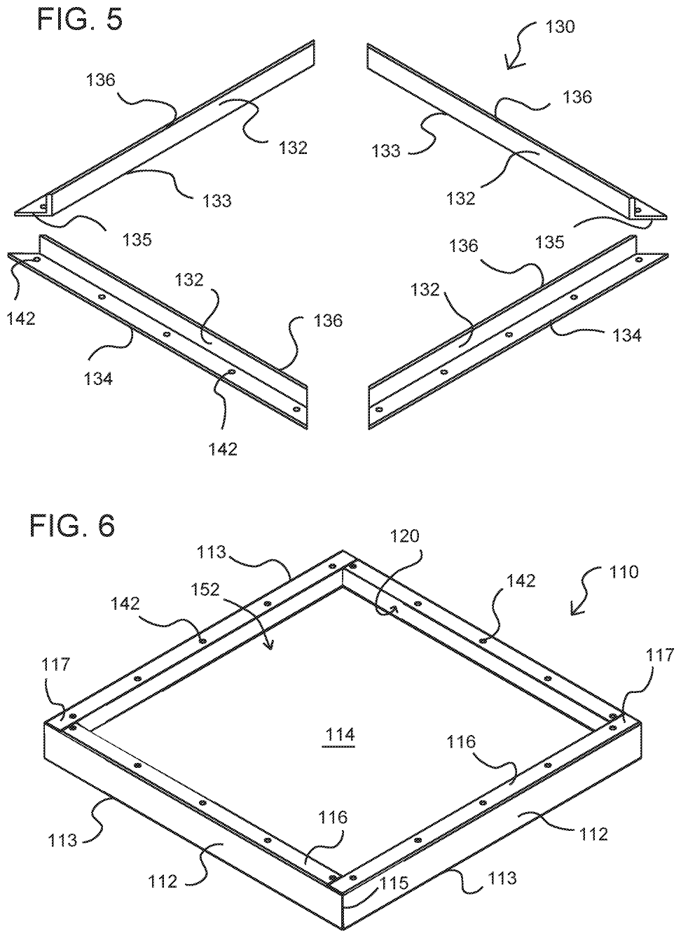

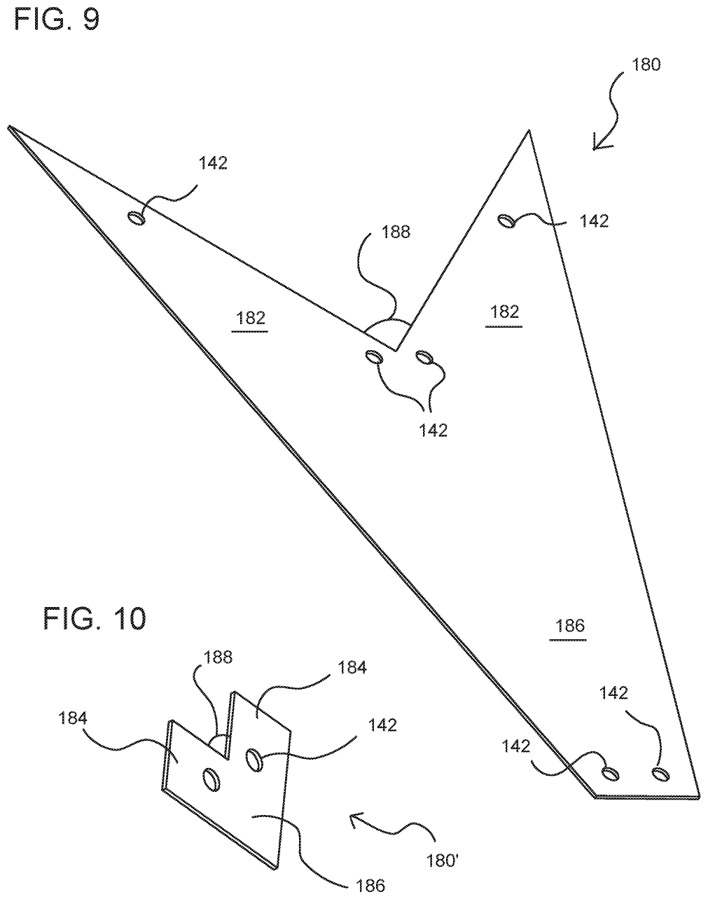

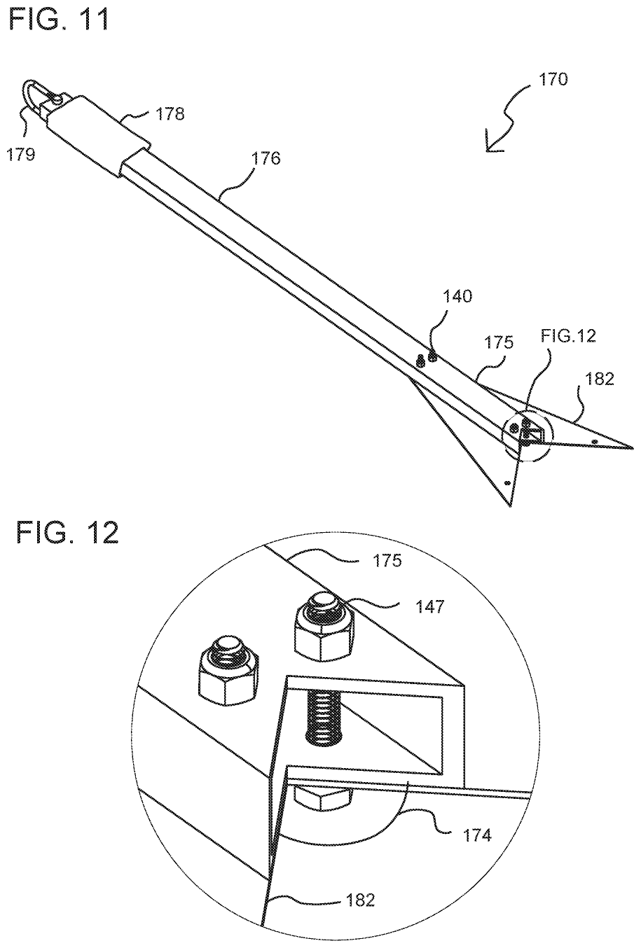

The preferred embodiment of the present invention is illustrated in FIGS. 1-12. FIG. 1 shows a perspective view of a handrail catch basket 100 as it may be used according to the present invention. The basket 100 is shown supported on a handrail 10, and anchor points 102 are provided for attaching additional tethers 12 which is shown attached to tool 14 being used by a worker. The basket 100 has a strainer 110, a trough 120, ledge 130, fasteners 140, inlet 150, chamber 152, stabilizing brackets 160, and handle 170.

FIG. 1A is a view of the handrail catch basket system 100 from FIG. 1 in use on a handrail which is tilted. Specifically, the basket 100 shown here is supported on a handrail 10 which is tilted at an angle 10A away from the horizon (dotted line not numbered, generally considered to be parallel with the bottom of the page seen). When the tool 14 from FIG. 1 was dropped by the user, it was above the inlet 150 and fell within the chamber 152. When the basket 100 was tilted at an angle 10A, the tool 14 was retained within trough 120, and prevented from falling upon anyone below.

FIG. 1B is a view of the handrail catch basket system 100 from FIG. 1 in use on another handrail which is tilted. This time however, when the tool 14 from FIG. 1 was dropped by the user, it was far removed from the inlet 150 and fell beyond the basket chamber 152. However, the tool 14 was retained by the tether 12 at anchor point 102 and still prevented from falling upon anyone below.

Base

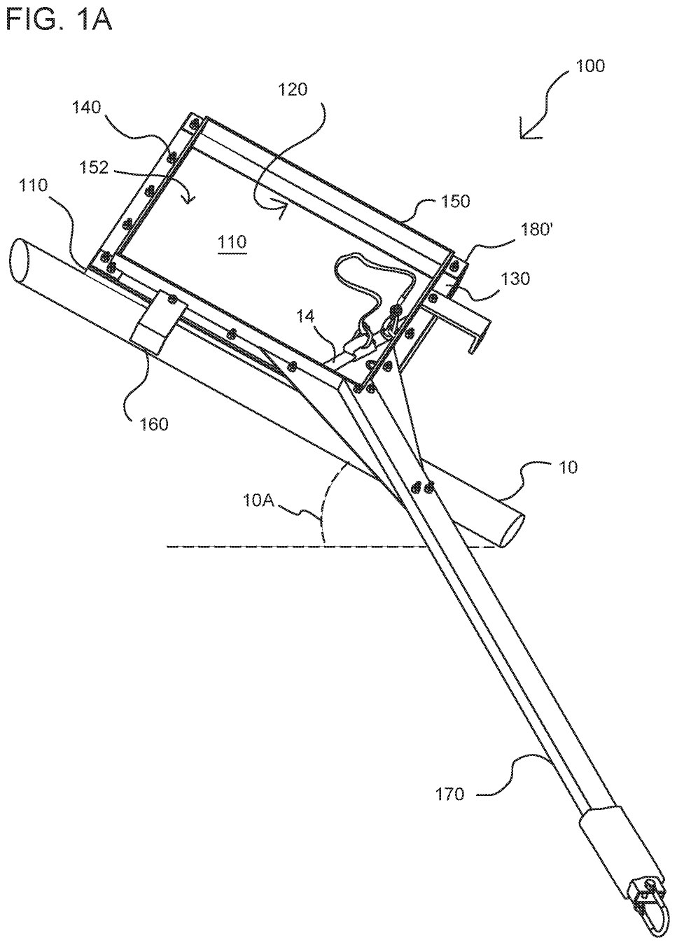

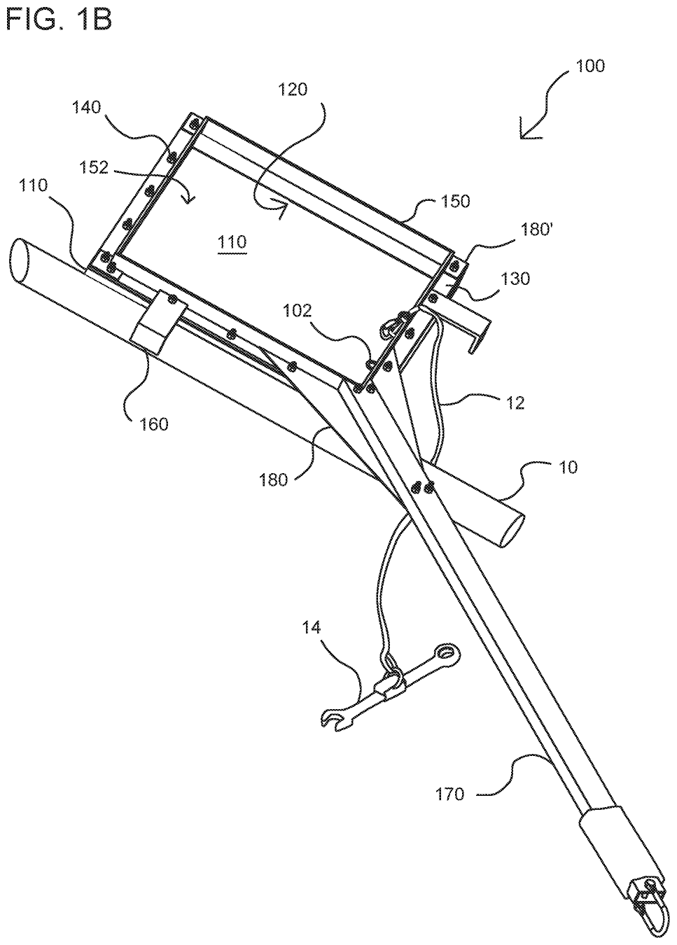

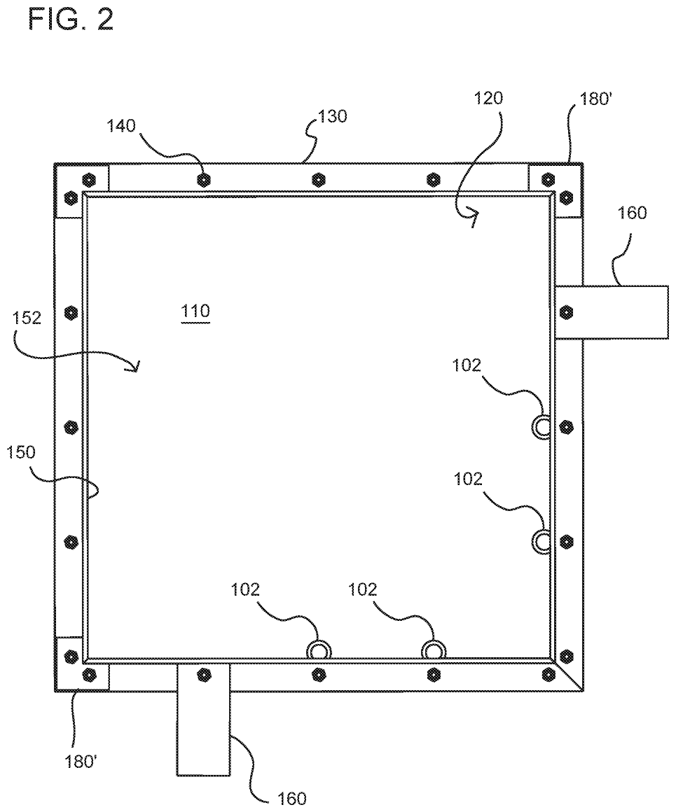

Although shown generally in FIG. 1, further details of the base 110 are shown in additional detail in FIGS. 2-4, and 6. In this embodiment, the base 110 of the basket is a strainer 110 having 0.13 inch perforations 111 which allows a user to spray water on parts within the chamber 152 to keep the parts wet and helps reduce radioactive contamination from spreading. The sidewalls 112 in this embodiment are simply extending portions of the bottom wall 114 having bends 113 at specific intervals so as to meet along the edges 115. Similarly, the top retaining walls 116 are further extending portions of the sidewalls 112, having further bends 113, at further intervals, with partial overlapping sections 117.

The strainer is about 0.05 inches thick in this embodiment, so that each of the top walls 116, sidewalls 112, and bottom wall 114 are also about 0.05 inches thick. The sidewalls 112 of the strainer 110 are approximately 2.14 inches tall, extending from the bend 113 adjacent the bottom wall 114 to the bend 113 adjacent the top wall 116; and are approximately 10.14 inches long, extending between the vertices 115 along adjacent side walls 112. Similarly, the top walls 116 are also approximately 10.14 inches long, if one includes the length of the overlapping portions 117. The width (or length, depending upon perspective) of the overlapping portions 117 will be relative to the width of the top wall 116, in this embodiment, approximately 1.05 inches.

Anchors and Tethers

Tethering anchors 102, illustrated in FIGS. 1-3 and FIG. 8, are secured along sidewalls 112 of the base 110 and include an anchor body 108 with a first end 103 and a second end 105, a first opening 104 and a second opening (fastener aperture) 142. Both openings 104, 142 are transverse to the longitudinal axis of tethering anchor 102. The first anchor opening 104 is spaced laterally from the fastener aperture 142. Both openings 104, 142 extend completely through the anchor body 108.

First anchor opening 104 has a diameter 104D (or cross-sectional area) larger than a diameter 142D (or cross-sectional area for noncircular apertures) of the fastener aperture 142. The increased size between these two cross-sectional areas facilitates secure attachment of the anchor 102 to the basket base 110 while also enabling free rotation of any tethers 12 attached to the first anchor opening 104.

The second anchor opening 142 (or fastener aperture 142) is spaced slightly from the second anchor end 105 providing a retaining edge to provide additional structural support for engaging the fastener 142 of the basket 100.

The size of the first anchor opening 104 to second anchor opening 143 is dependent on the diameter of the size of the tether clips and fasteners 142 employed. Although tethering anchor 102 shown in FIGS. 1, 2, and 8 are shown having have semi-circularly shaped first and second anchor ends 103 and 105, respectively, it is contemplated that the shape of first and second ends 103 and 105 may be of any configuration so long as tethering anchor 102 can be used for its intended purpose. The intended purpose being that tethering anchor 102 is connectable to the base 110 along the rim along the second anchor end, while presenting the first anchor end 104 for attachment to the clip of a tool tether which can then freely rotate. It is also contemplated that the peripheral shape of tethering anchor 102 may also have any configuration so long as tethering anchor 102 can be used for its intended purpose. Tethering anchor 102 is made of a rigid or semi-rigid material. Examples of such materials are metal, plastic, and the like.

Although the tether 12 shown in FIGS. 1-1B are shown having a clip portion attached to the tethering anchor 102, it is contemplated that the portion of the tether 12 attached to the anchor 102 would be irremovable. That is, in one embodiment of the present invention, a portion of the tether is irreversibly secured to the first anchor end 103. It is also contemplated that the shape of tether 12 and clip may also have any configuration and length so long as tether 12 can be used for its intended purpose.

Trough

Best use of the trough 120 is illustrated in FIG. 1A, and various aspects of the trough are seen in FIGS. 1-4 and FIG. 6. The trough 120 is a feature of the present invention to increase overall safety which circumvents the main chamber 152 of the basket 100. By providing an extra ‘catch’ cavity surrounding the main chamber 152 of the basket 110 and by having a perimeter greater than a perimeter of the inlet 150, the trough 120 is capable of retaining any of the interior parts 12 even if the basket 110 is inadvertently angled while being moved.

That is, without the trough 120, the chamber 152 would have the same perimeter size as the inlet 150, and if the basket 100 was shifted so that the bottom 114 of the base was no longer horizontal, then the center of gravity of an object or tool 12 within the basket could cause gravity to act upon any tools 12 within the basket 100, tipping them out of the basket 100 without additional inertia or external force.

The width of the top wall 116 inevitably determines the width of the trough 120, an additional partially enclosed space encompassing the perimeter of the main basket inlet 150. For a rectangular shaped basket then, the volume of the trough 120 will likewise approach four times the width of the top wall 116 times the height of the sidewall 112. In another embodiment, where the base 10 lacks an upper lip 116, the size of the trough 120 would depend upon the size of the bottom wall 134 of the ledge 130 accordingly.

It is to be recognized that the concept of the trough 120 is to be employed for bases 110 of the present invention of other shapes as well. The trough 120 provides extra protection against drop spills by surrounding the chamber 152 of the basket 100 in all 360-degrees of a center of the chamber 152. That is, the trough 120 surrounds the chamber 152 regardless of basket shape—in the embodiment shown in the figures, the base is rectangular so that the trough extends in a rectangular fashion. If the main base was a columnar shape, the trough 120 would extend 360-degrees in a tubular fashion around the base 110.

Ledge

One embodiment of the ledge is illustrated in FIGS. 1-5. In this embodiment, the ledge 130 has a side wall 132 which extends from a bottom wall 134 at bend 133 so that the bottom wall 134 and side wall 132 are integrated for increased strength and support. The upper most lip 136 of the side wall 132 encompasses and defines the perimeter of the inlet 150.

In some embodiments the side walls 132 of the ledge 130 are straight lines, so the size of the inlet will remain constant as it transitions into the main chamber 152. In other embodiments, the sidewall 132 are angled outwards to provide a wider inlet than the main chamber 152 size, in order to provide a funnel shape to encourage tool entrance into the main chamber 152. In other embodiments, the sidewalls 132 are angled inwards to provide a narrower inlet than the main chamber 152 size, in order to increase the overall trough 120 size.

With regard to overall structure, in some embodiments the ledge has four components which each make up the ledge 139 as a whole. Each ledge component meets an adjacent ledge component along vertices 135 which are cut at 45-degree angles so as to complement the adjacent vertex of a respective ledge component. Angled braces 180 with smaller arms 184 are provided for these embodiments to provide further security and support. In other embodiments, there is a single ledge with overlapping portions having structures similar to the overlapping sections 117 in various embodiments of the strainer top walls 116.

Fasteners

FIGS. 1-4 and FIGS. 11-12 illustrate various fasteners 140 which are employed as connecting elements for each of the strainer 110, trough 120, ledge 130, stabilizing brackets 160, handle 170, and braces 172, 180. Fastener apertures 142 are present in each of strainer 110, trough 120, ledge 130, stabilizing brackets 160, handle 170, and braces 172, 180. These fastener apertures 142 are sized to accommodate the shaft 148 of the fastener 140 employed. The fasteners employed 140 are structurally designed to exhibit or otherwise visually illustrate engagement of the fastener and/or warn against potential disengagement.

In the embodiment shown here, the fasteners 140 are reversed bolts, having the heads 144 on the inside of the chamber, and the shafts 148 and bolts 148 visible on the outside or outside of the basket 100. However, any fastener 140 capable of illustrating and/or warning against potential disengagement is within the scope of the present invention. Cap screws with tie wires or other irreversible fasteners 140 are also within the scope of the present invention.

FIG. 12 illustrates one potential embodiment for illustrating one method of alerting a user about potential disengagement through visual indicators 147. That is, a visual indicator 147 is placed upon an upper portion of the shaft 148 above the nut 146 which indicates proper placement. In the event that partial disengagement occurs, the visual indicator 147 will fall below the nut 147, the lack of which provides a visual warning to the user. For example, the visual indicator 147 could be a green band, indicating that everything is “in order” and “good to go”, such that when partial disengagement occurs, the green band 147 will be below the nut 147, so that a user can clearly see that everything is no longer “good to go”.

Inlet

The inlet 150, in the embodiment shown in FIGS. 1-4, is the mouth formed by the perimeter of the uppermost edges of the sidewalls 132 of the ledge 130. The inlet 150 leads into the main chamber 152 and trough 120 bounded by the sidewalls of the strainer 110.

In alternative embodiments, the inlet is formed by an extension of the base and this structure is contrary to the scope of the invention. In these alternative embodiments, if the size of the inlet may remain constant as it transitions into the main chamber 152. In other embodiments, the structure forming the inlet is angled outwards to provide a wider inlet than the main chamber 152 size, in order to provide a funnel shape to encourage tool 14 entrance into the main chamber 152. In other embodiments, the structure forming the inlet 150 forms the trough 120 as well, and thus, directly impacts the size of the trough 120. The inlets 150 in these embodiments must, then, have a much smaller size than a size of the main chamber 152, in order to increase the overall size of the trough 120 with respect to the main chamber 152.

Brackets

FIGS. 1-4 and FIG. 7 illustrate stabilizing brackets 160, which are provided on either side of the main strainer base 110 for securing and stabilizing the basket 110 with respect to a railing 10. The main portion 162 has a fastener aperture extending vertically throughout which is sized to accommodate the shaft 148 of the fasteners which are employed to secure the brackets 160 to the main base 110. The retaining portion 162 extends vertically downwards from the main portion 164 via the bend 163. In this embodiment, the stabilizing bracket 160 forms a simple L-shape, however, it is anticipated that the retaining portion 162 may not be straight, but also curved, so that the overall shape is r-shaped.

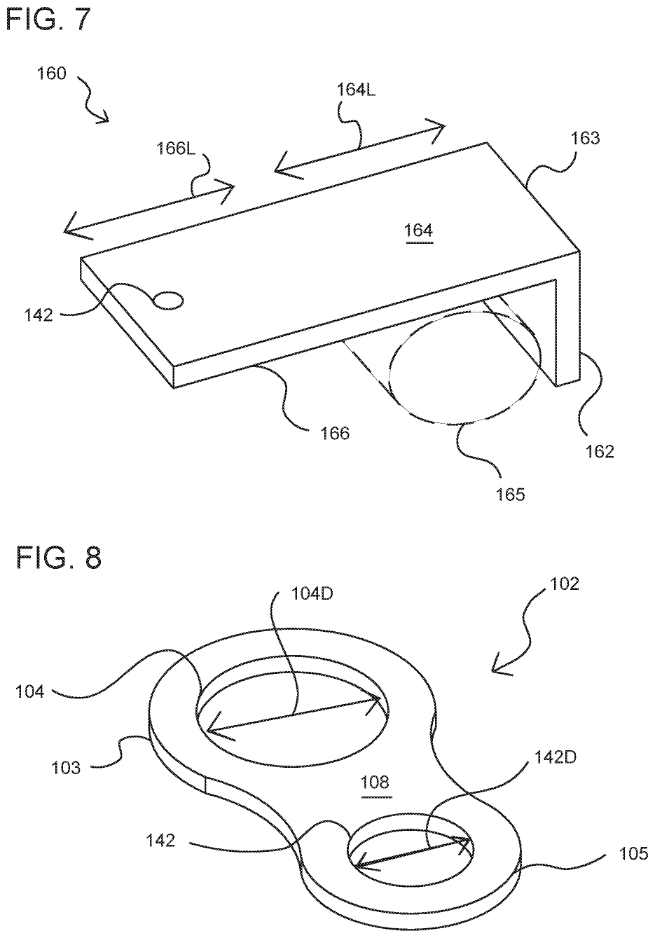

Along the same lines, instead of merely providing a single stabilizing bracket along either side of the handle, the present invention also anticipates embodiments having a set of stabilizing brackets with clamps so that the basket is self-supporting. That is, the railing-space 165 under the bracket 160 has a size which is defined by the retaining portion 162 and the main portion 164. In the embodiment shown in FIG. 7, the downward extending height of the retaining portion 162 is approximately 1.5 inches which is sufficient to provide counterbalancing force and support against the shear forces involved for most sized railings with the additional support provided by the handle 170 (supported either by hand at the grip 178 or via attachment at the u-shackle 179 as discussed in greater detail below).

Handle

As shown in FIGS. 1-1B and FIGS. 11-12, the handle 170 has an inverted v-shaped portion 175 (or neck) so that an angled portion extends for at least a small length along each adjacent portions of the respective ledge 130 sidewalls 132 and bottom 134. The angle 174 at the portion of the neck is complementary to the abutting portions of the sidewalls 132 and generally complementary to the angle 188 of the brace 180 supporting the handle 170.

The main shaft 176 of the handle extends from the neck 175 away from the base 110 towards a grip 178. The grip 178 may be formed of an extra material wrapped around the shaft of the handle, or simple a portion of the shaft of the handle itself.

A U-shackle extends vertically through an end of the shaft 176 adjacent to or within the grip 178. The U-shackle 179 is generally of sufficient strength, such that if correctly attached by a user to a third attachment point, the basket 100 may be supported securely upon the railing without additional user support.

Brace

Braces, according to the present invention, are illustrated in FIGS. 1-4 and FIGS. 9-12. A series of braces 180, 180′ are found on each vertex of the basket 100. Each brace 180, 180′ as shown in this embodiment has two arms 182, 184 which extend along two bottom walls 134 and provide support 135 for the corners. A brace 180 having larger arms 182 supports the handle 170, and extends, not just to either side, but also underneath the handle 170. A series of angle braces 180′ having smaller arms 184 are used to secure edges of the ledge 130 and further secure and support the weight stress along those corner points.

For each type of brace 180, 180′, the arms 182, 184 extend apart from one another at an angle 188 which complements the vertices of the strainer 110. The arms 182, 184 may end in either a diagonal or rectangular form as they extend from the main body 186. Regardless of the end shape however, each brace 180, 180′ will typically have at least one fastener aperture 142 per arm 182, 184. In the larger brace 180, the arms 182 have two fastener apertures 142 each, and the main body 188 has two additional fastener apertures 142 for securing the handle 170 thereto.

### LIST OF REFERENCED ELEMENTS

The following reference numbers are adhered to within the specification to refer to those referenced elements within the drawings of the present application.

| | |
|---|---|
| Handrail 10 | Small portion 105 |
| Tethers 12 | Large portion 103 |
| Catch basket 100 | Large aperture 104 |
| Anchor points 102 | Strainer 110 |
| Main body 108 | Perforations 111 |
| Sidewalls 112 | Inlet 150 |
| Bends 113 | Chamber 152 |
| Bottom wall 114 | Stabilizing brackets 160 |
| Vertices 115 | Side wall portion 162 |
| Top retaining wall 116 | Bend 163 |
| overlapping sections 117 | Main portion 164 |
| Trough 120 | Rail-space 165 |
| Ledge 130 | Arm 166 |
| Side wall 132 | Handle 170 |
| Bend 133 | Abutting angle 174 |
| Bottom wall 134 | Neck 175 |
| Fasteners 140 | Main shaft 176 |
| Fastener apertures 142 | Grip 178 |
| Heads 144 | U-shackle 179 |
| Nuts 146 | Angle braces 180 |
| Bolt 148 | Long arms 182 |
| First indicator 147 | Short arms 184 |

### CONCLUSION

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A handrail catch basket supported by a handrail for containing tools and attaching safety tethers for said tools, the basket comprising:
a base having a sidewall extending from a bottom sheet, and an upper rim extending from the sidewall, the base defining an internal chamber and a trough for retaining said tools;
a brace providing additional support along the upper rim, the brace having two arms extending from a main portion at an angle, and the two arms each abutting a respective portion of the sidewall of the base and supported on a respective portion of the rim portion;
at least two points of support, being able to physically support an entire weight of the basket; and
one of the at least two points of support being a stabilizing bracket having: a supporting arm securely supporting the base, and a main body extending between the supporting arm and a retaining arm, the main body and retaining arm defining a railing-space under the bracket, and respective surfaces of the main body and the retaining arm facing the railing-space being friction-free so as to facilitate sliding engagement laterally along the handrail.

2. The handrail catch basket of claim 1, wherein a second of the at least two points of support being a handle; the handle having a neck which securely supports the base, and a shaft which extends between the neck and a grip; the grip capable of being supported by hand or by attachment point along the grip.

3. The handrail catch basket of claim 1, wherein a second of the at least two points of support being a second stabilizing bracket having:
a second supporting arm securely supporting the base; and
a second main body extending between the second supporting arm and a second retaining arm;
wherein the second main body and second retaining arm defining a second railing-space under the second bracket, and respective surfaces of the second main body and the second retaining arm facing the second railing-space being friction-free so as to facilitate sliding engagement laterally along the handrail.

4. The handrail catch basket of claim 1, further comprising a tethering anchor secured along an inside portion of the sidewall of the base, the tethering anchor comprising:
an anchor body extending between a first end and a second end;
a first opening in the first end; and
a second opening in the second end;
wherein the first and the second openings are transverse to a longitudinal axis of tethering anchor; the first opening is spaced laterally from the second opening; the first and the second openings extend completely through the first end and the second end, respectively; and the first opening has a diameter greater than a diameter of the second opening.

5. The handrail catch basket of claim 1, wherein the trough surrounds the inner chamber of the base, facilitating retaining said tools when the basket is positioned at an angle away from a horizon.

6. The handrail catch basket of claim 1, wherein the base is a strainer having perforations.

7. A handrail catch system, capable of being supported by a handrail and capable of holding, capturing, and retaining tools, the system comprising:
a basket having a sidewall extending from a bottom sheet, and the base defining an internal chamber for holding said tools;
two stabilizing brackets, each of the two stabilizing brackets having: a supporting arm securely supporting the basket, and a main body extending between the supporting arm and a retaining arm, the main body and retaining arm defining a railing-space under the respective bracket, and respective surfaces of the main body and the retaining arm facing the railing-space being friction-free so as to facilitate sliding engagement of the basket laterally along the handrail; and
at least one retaining system, wherein the at least one retaining system is one of: a trough surrounding the inner chamber of the basket, formed by an upper rim extending from the sidewall; and an anchor and tether system connected to the basket, having at least one clip for attachment to one of said tools; and wherein the at least one retaining system facilitates in retaining and capturing said tools when the basket is positioned at an angle away from a horizon.
